(19) United States
(12) Patent Application Publication
(10) Pub. No.: US 2014/0305646 A1
(43) Pub. Date: Oct. 16, 2014

(54) COMPOSITION OF POLYBUTADIENE-BASED FORMULA FOR DOWNHOLE APPLICATIONS

(71) Applicants: Andrew Chew, Houston, TX (US); Guido De Stefano, Spring, TX (US); Steven Young, Cypress, TX (US); Jason T. Scorsone, Houston, TX (US); Matthew Offenbacher, Houston, TX (US)

(72) Inventors: Andrew Chew, Houston, TX (US); Guido De Stefano, Spring, TX (US); Steven Young, Cypress, TX (US); Jason T. Scorsone, Houston, TX (US); Matthew Offenbacher, Houston, TX (US)

(73) Assignee: M-I L.L.C., Houston, TX (US)

(21) Appl. No.: 14/126,956

(22) PCT Filed: Jun. 18, 2012
(86) PCT No.: PCT/US12/42948

§ 371 Date: Mar. 18, 2014

Related U.S. Application Data
(60) Provisional application No. 61/498,305, filed on Jun. 17, 2011.

(51) Int. Cl. C09K 8/575; E21B 43/00

(52) U.S. Cl. CPC C09K 8/5753; E21B 43/00
USPC 166/305.1; 507/221; 507/224

(57) ABSTRACT

A method of treating a wellbore may include emplacing in at least a selected region of the wellbore a formulation that includes at least one diene pre-polymer; at least one reactive diluent; at least one inert diluent comprising an oleaginous liquid or a mutual solvent; and at least one initiator; and initiating polymerization of the at least one diene pre-polymer and the at least one reactive diluent to form a composite material in the selected region of the wellbore.

### BACKGROUND

Oilfield drilling typically occurs in geological formations having various compositions, permeabilities, porosities, pore fluids, and internal pressures. Weak zones may occur during drilling due to these formations having a variety of conditions. These weak zones may lead to fluid loss, pressure changes, well cave-ins, etc. The formation of weak zones is detrimental to drilling because they need to be strengthened before drilling work may resume.

Weak zones may occur, for example, when the fracture initiation pressure of one formation is lower than the internal pore pressure of another formation. As another example, increased borehole pressure, created by penetrating one formation, may cause a lower strength formation to fracture. As another example, the fluid pressure gradient in a borehole required to contain formation pore pressure during drilling may exceed the fracture pressure of a weaker formation exposed in a borehole.

Cement, or other fluid compositions used for strengthening weak zones, may also be used in the case of primary cementing operations, lost circulation of the drilling mud, and/or zonal isolations. In primary cementing operations, at least a portion of the annular space between the casing and the formation wall is filled with a cementitious composition, after which time the cement may then be allowed to solidify in the annular space, thereby forming an annular sheath of cement. The cement barrier is desirably impermeable, such that it will prevent the migration of fluid between zones or formations previously penetrated by the wellbore.

Lost circulation is a recurring drilling problem, characterized by loss of drilling mud into downhole formations that are fractured, highly permeable, porous, cavernous, or vugular. These earth formations can include shale, sands, gravel, shell beds, reef deposits, limestone, dolomite, and chalk, among others. Other problems encountered while drilling and producing oil and gas include stuck pipe, hole collapse, loss of well control, and loss of or decreased production.

Induced mud losses may also occur when the mud weight, required for well control and to maintain a stable wellbore, exceeds the fracture resistance of the formations. A particularly challenging situation arises in depleted reservoirs, in which the drop in pore pressure weakens hydrocarbon-bearing rocks, but neighboring or inter-bedded low permeability rocks, such as shales, maintain their pore pressure. This can make the drilling of certain depleted zones impossible because the mud weight required to support the shale exceeds the fracture resistance of the sands and silts.

Other situations arise in which isolation of certain zones within a fottnation may be beneficial. For example, one method to increase the production of a well is to perforate the well in a number of different locations, either in the same hydrocarbon bearing zone or in different hydrocarbon bearing zones, and thereby increase the flow of hydrocarbons into the well. The problem associated with producing from a well in this manner relates to the control of the flow of fluids from the well and to the management of the reservoir. For example, in a well producing from a number of separate zones (or from laterals in a multilateral well) in which one zone has a higher pressure than another zone, the higher pressure zone may disembogue into the lower pressure zone rather than to the surface. Similarly, in a horizontal well that extends through a single zone, perforations near the “heel” of the well, i.e., nearer the surface, may begin to produce water before those perforations near the “toe” of the well. The production of water near the heel reduces the overall production from the well.

In attempting to cure these and other problems, crosslinkable or absorbing polymers, loss control material (LCM) pills, and cement squeezes have been employed. Cement compositions and/or gels, in particular, have found utility in preventing mud loss, stabilizing and strengthening the wellbore, and zone isolation and water shutoff treatments.

Despite many valuable contributions from the art, it would be beneficial to develop compositions that have desirable material properties for use downhole.

### SUMMARY

In one aspect, embodiments disclosed herein relate to a method of treating a wellbore that includes emplacing in at least a selected region of the wellbore a formulation that includes at least one diene pre-polymer; at least one reactive diluent; at least one inert diluent comprising an oleaginous liquid or a mutual solvent; and at least one initiator; and initiating polymerization of the at least one diene pre-polymer and the at least one reactive diluent to form a composite material in the selected region of the wellbore.

In another aspect, embodiments disclosed herein relate to a composite material that includes a crosslinked polymer network of a diene polymer and cycloalkyl ester of (meth)acrylate; and a plurality of weighting agent particles and/or rheological additive dispersed in the crosslinked polymer network.

In yet another aspect, embodiments disclosed herein relate to a composite material that includes a crosslinked polymer network of a diene homopolymer, a (meth)acrylated diene polymer, and one of 4-acryloylmorpholine, 2-phenoxyethyl(meth)acrylate, isodecyl(meth)acrylate, lauryl(meth)acrylate, isobornyl(meth)acrylate, trimethylolpropane tri(meth)acrylate, tripropylene glycol di(meth)acrylate, or bisphenol A ethoxylate diacrylate; and a plurality of weighting agent particles and/or rheological additive dispersed in the crosslinked polymer network.

Other aspects and advantages of the invention will be apparent from the following description and the appended claims.

### BRIEF DESCRIPTION OF DRAWINGS

FIG. 1 illustrates the testing of the unconfined compressive strength of sample materials.

FIG. 2 illustrates a sample subjected to the unconfined compressive strength test.

FIGS. 3A-3C show the effect of contamination on the unconfined compressive strength of sample composite materials.

FIG. 4 shows the exothermic profile for a sample material.

FIG. 5 shows the unconfined compressive strength of a sample material.

FIG. 6 shows a sample subjected to the unconfined compressive strength test.

FIG. 7 shows a schematic of a wellbore operation.

FIG. 8 shows a schematic of a wellbore operation.

FIG. 9 shows a schematic of a wellbore operation.

### DETAILED DESCRIPTION

The embodiments may be described in terms of treatment of vertical wells, but is equally applicable to wells of any orientation. The embodiments may be described for hydrocarbon production wells, but it is to be understood that the embodiments may be used for wells for production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

Embodiments disclosed herein relate generally to diene-based compositions used in downhole applications, such as wellbore strengthening, zonal isolations or sealing applications. More specifically, embodiments disclosed herein relate to composite materials for downhole applications formed of a polybutadiene polymer and a reactive diluent. The inventors of the present disclosure has found that the combination of the diene polymer such as polybutadiene and the reactive diluent(s) may result in a composite material that exhibits an ability to absorb energy and deform without fracturing, i.e., the material exhibits toughness, as well as a degree of rigidity. Each component may be selected and used in a desired relative amount to result in the desired properties for the particular application.

Upon curing, the diene pre-polymer and the reactive diluents form a composite network of the diene pre-polymer and the reactive diluents having crosslinks formed between diene polymer chains, crosslinks formed between a diene polymer chain and a reactive diluent, and/or bonds between two or more reactive diluents that may optionally include formation of a domain of polymerized reactive diluents. The pre-cured formulation may also include an inert diluent, as well as one or more additives.

Diene Pre-Polymer

The ability of the composite material to absorb energy and deform without fracture may be attributed to the diene prepolymer. As used herein, a “diene pre-polymer” may refer to a polymer resin formed from at least one aliphatic conjugated diene monomer. Examples of suitable aliphatic conjugated diene monomers include C₄ to C₉ dienes such as butadiene monomers, e.g., 1,3-butadiene, 2-methyl-1,3-butadiene, and 2-methyl-1,3-butadiene. Homopolymers or blends or copolymers of the diene monomers may also be used. In yet another embodiment, one or more non-diene monomers may also be incorporated in the diene pre-polymer, such as styrene, acrylonitrile, etc. In particular embodiments, at least two diene pre-polymers may be used. In such embodiments, the at least two diene pre-polymers may include a diene homopolymer (1,3 butadiene homopolymer) used in conjunction with a derivatized diene oligomer, such as a (meth)acrylated polybutadiene. A (meth)acrylated diene oligomer may be formed by reacting a diene oligomer with a glycidyl(meth)acrylate or a hydroxyl terminated diene oligomer with alkaline oxide followed by transesterfication with a (meth)acrylate ester. A particular example includes polybutadiene di(meth)acrylates sold by Sartomer Company Inc. (Exton, Pa.).

The diene pre-polymers of the present disclosure may have a number average molecular weight broadly ranging from about 500 to 10,000 Da. However, more particularly, the number average molecular weight may range from about 1000 to 5000 Da, and even more particularly, from about 2000 to 3000 Da. For diene resins, microstructure refers to the amounts 1,2- versus 1,4-addition (for example) and the ratio of cis to trans double bonds in the 1,4-addition portion. The amount of 1,2-addition is often referred to as vinyl content due to the resulting vinyl group that hangs off the polymer backbone as a side group. The vinyl content of the diene prepolymer used in accordance of the present disclosure may range from about 5% to about 90%, and from about 50% to 85% in a more particular embodiment. The ratio of cis to trans double bonds may range from about 1:10 to about 10:1. Various embodiments of the above described prepolymers may be non-functionalized; however, functionalization such as hydroxyl terminal groups or malenization may be used in some embodiments. For example, the average number of reactive terminal hydroxyl groups or maleic anhydride functionalization per molecule may range from about 1 to 3, but may be more in other embodiments.

Selection of the particular prepolymer may be based on several factors, for example, such as the degree rigidity desired for the particular application, the amount of crosslinking desired, viscosity in a pre-cured state, flashpoint, etc.

The diene pre-polymer(s) may be used in an amount ranging from about 5 to about 50 weight percent, based on the total weight of the formulation, from about 8 to about 35 weight percent in other embodiments, and from about 10 to about 30 weight percent in yet other embodiments.

Reactive Diluent

The reactive diluents may be included in the formulation to lower the viscosity of the diene prepolymer and also increase the tensile strength and flexural strength of the cured solid composite material. Increased tensile and flexural strength of the composite material may be due to the steric hindrance of the reactive diluents within the polymer network after curing. Chemically, the reactive diluents may be an ester or amide of unsaturated carboxylic acids, (including di- or tri-carboxylic acids) such as an alkyl ester or amide, a cycloalkyl (including heterocycles) ester or amide of (meth)acrylate. For example, particular embodiments may use such a monomer having a substituted or unsubstituted (excluding polar or hydrophilic substituents), cyclic or bicyclic ring structure at the alpha or beta carbon position. Particular substituents may include C1-C3 alkyl groups. Specific examples of reactive diluents include 4-acryloylmorpholine, 2-phenoxyethyl(meth)acrylate, isodecyl(meth)acrylate, lauryl(meth)acrylate, isobornyl(meth)acrylate, trimethylolpropane tri(meth)acrylate, tripropylene glycol di(meth)acrylate, and bisphenol A ethoxylate diacrylate. In particular embodiments, combinations of two or more reactive diluents may be used, such as for example, a combination of isobornyl acrylate with trimethylolpropane trimethacrylate.

Particularly suitable reactive diluents may be in liquid form, having a viscosity at 25° C. ranging from about 2 to 50 cps (or 2 to 20 cps in particular embodiments) and a glass transition temperature (for the corresponding homopolymerized reactive diluents) in the range of 90 to 130° C., and may be at least oil-miscible. Alternative reactive diluents that may be used instead of or in addition to (meth)acrylates include other vinyl monomers which might increase the network of the final product and therefore it's mechanical properties capable of anionic addition polymerization (without chain transfer or termination) that contain non-polar substituent(s) on the vinyl group that can stabilize a negative charge through delocalization such as styrene, epoxide, vinyl pyridine, episulfide, N-vinyl pyrrolidone, and N-vinyl caprolactum or molecules with two or more vinyl or acrylate groups.

The reactive diluent may be used in an amount ranging from about 25 to about 80 weight percent, based on the total weight of the formulation, from about 30 to about 75 weight percent in other embodiments, from about 35 to about 75 weight percent in other embodiments, from about 45 to 80 weight percent in other embodiments, and from about 45 to about 65 weight percent in yet other embodiments.

In yet other embodiments, the reactive diluent may have a lower limit of any of 25, 30, 35, 40, or 45 weight percent, and an upper limit of any of 40, 45, 50, 60, 70, 75, or 80 weight percent, where any lower limit can be used with any upper limit.

Further, in embodiments, the amount of reactive diluent may be in excess of the at least one diene prepolymer. For example, the amount of reactive diluent relative to the amount of diene prepolymer(s) may be at least 2:1, or at least 3:1, 4:1, 5:1, 6:1, and/or in some embodiment may be up to 7:1, 8:1, 9:1, or 10:1, where any lower limit may be used in combination with any upper limit

Inert Diluent

An inert diluent, i.e., solvent, may also be incorporated to achieve desired viscosity and rheology of the pre-cured formulation. Such solvents that may be appropriate may comprise any oil-based fluid used in downhole applications, such as diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof, as well as any mutual solvent, examples of which include a glycol ether or glycerol. The use of the term “mutual solvent” includes its ordinary meaning as recognized by those skilled in the art, as having solubility in both aqueous and oleaginous fluids. In some embodiments, the mutual solvent may be substantially completely soluble in each phase while in select other embodiment, a lesser degree of solubilization may be acceptable. Illustrative examples of such mutual solvents include for example, alcohols, linear or branched such as isopropanol, methanol, or glycols and glycol ethers such as 2-methoxyethanol, 2-propoxyethanol, 2-ethoxyethanol, diethylene glycol monoethyl ether, dipropylene glycol monomethyl ether, ethylene glycol monobutyl ether, ethylene glycol dibutyl ether, diethylene glycol monoethyl ether, diethyleneglycol monomethyl ether, tripropylene butyl ether, dipropylene glycol butyl ether, diethylene glycol butyl ether, butylcarbitol, dipropylene glycol methylether, various esters, such as ethyl lactate, propylene carbonate, butylene carbonate, etc, and pyrolidones. The inert diluent solvent may be present in an amount ranging from 8 to 40 percent by weight, from 10 to 30 percent by weight in another embodiment, and from 20 to 30 percent by weight of the fluid formulation in a more particular embodiment. In particular embodiments, the diluent solvent may be selected from diesel oil; mineral oil; or a synthetic oil, without the use of a mutual solvent.

Initiator

In embodiments, the polymers and/or monomers are contacted with at least one initiator in order to effect the formation of the composite. In general, the initiator may be any nucleophilic or electrophilic group that may react with the reactive groups available in the polymers and/or monomers. In further embodiments, the initiator may comprise a polyfunctional molecule with more than one reactive group. Such reactive groups may include for example, amines, alcohols, phenols, thiols, carbanions, organofunctional silanes, and carboxylates.

Examples of initiators include free radical initiating catalysts, azo compounds, alkyl or acyl peroxides or hydroperoxides, dialkyl peroxides, ketoperoxides, peroxy esters, peroxy carbonates, peroxy ketals, and combinations thereof. Examples of free radical initiating catalysts include benzoyl peroxide, di(3,5,5-trimethylhexanoyl) peroxide, dibenzoyl peroxide, diacetyl peroxide, di-n-nonanoyl peroxide, disuccinic acid peroxide, di-t-butyl peroxide, cumyl peroxide, dicumyl peroxide, di-n-propyl peroxydicarbonate, dilauroyl peroxide, tert-hexyl peroxyneodecanoate, t-butyl hydroperoxide, methyl ketone peroxide, acetylacetone peroxide, methylethyl ketone peroxide, dibutylperoxylcyclohexane, p-menthyl hydroperoxide, di(2,4-dichlorobenzoyl) peroxide, diisobutyl peroxide, t-butyl perbenzoate, t-butyl peracetate, and combinations thereof. Further, one skilled in the art would appreciate that any of the above initiators may be suspended in a diluent, such as a phthalate (including dialkyl phthalates such as dimethyl or diisobutyl phthalate, among others known in the art).

In preferred embodiments, the initiators may be peroxide based and/or persulfates. The amount of initiators is preferably from about 0.1 wt % to about 8 wt %, more preferably from about 0.2 wt % to about 1 wt %, most preferably from about 0.3 wt % to about 0.8 wt %.

Accelerators and Retardants

Accelerators and retardants may optionally be used to control the cure time of the composite. For example, an accelerator may be used to shorten the cure time while a retardant may be used to prolong the cure time. In some embodiments, the accelerator may include an amine, a sulfonamide, or a disulfide, and the retardant may include a stearate, an organic carbamate and salts thereof, a lactone, or a stearic acid.

Additives

Additives are widely used in polymeric composites to tailor the physical properties of the resultant composite and/or the initial fluid formulation. In some embodiments, additives may include plasticizers, thermal and light stabilizers, flame-retardants, fillers, adhesion promoters, rheological additives, or weighting agents.

Addition of plasticizers may reduce the modulus of the polymer at the use temperature by lowering its glass transition temperature (Tg). This may allow control of the viscosity and mechanical properties of the composite. In some embodiments, the plasticizer may include phthalates, epoxides, aliphatic diesters, phosphates, sulfonamides, glycols, polyethers, trimellitates or chlorinated paraffin. In some embodiments, the plasticizer may be a diisooctyl phthalate, epoxidized soybean oil, di-2-ethylhexyl adipate, tricresyl phosphate, or trioctyl trimellitate.

Fillers are usually inert materials which may reinforce the composite or serve as an extender. Fillers therefore affect composite processing, storage, and curing. Fillers may also affect the properties of the composite such as electrical and heat insulting properties, modulus, tensile or tear strength, compressive strength, abrasion resistance and fatigue strength. In some embodiments, the fillers may include carbonates, metal oxides, clays, silicas, mica, metal sulfates, metal chromates, carbon black, or carbon nanotubes. In some embodiments, the filler may include titanium dioxide, calcium carbonate, non-acidic clays, barium sulfate or fumed silica. The particle size of the filler may be engineered to optimize particle packing, providing a composite having reduced resin content. The engineered particle size may be a combination of fine, medium and coarse particles. The particle size may range from about 3 to about 500 microns. Fumed silica and carbon nanotubes may have a particle size range from about 5 nanometers to 15 nanometers.

Addition of adhesion promoters may improve adhesion to various substrates. In some embodiments, adhesion promoters may include modified phenolic resins, modified hydrocarbon resins, polysiloxanes, silanes, or primers.

Addition of rheological additives may control the flow behavior of the formulation prior to polymerization, and may aid in suspension of any weighting agents present in the formulation. In some embodiments, rheological additives may include fine particle size fillers, organic agents, or combinations of both. In some embodiments, rheological additives may include precipitated calcium carbonates or other inorganic materials, non-acidic clays such as organoclays including organically modified bentonite, smectites, and hectoriets, fumed silicas or other nano-sized silicas including those coated with a hydrophobic coating such as dimethyldichlorosilane, carbon nanotubes, synthetic or natural fibrous structures (such as those described in WO 2010/088484, which is herein incorporated by reference), grapheme, functionalized grapheme, graphite oxide, styrenic block copolymers, or modified castor oils. Rheological additives may be present in an amount up to 10 ppb, and between 1 ppb to 8 ppb in particular embodiments. Further, it is also within the scope of the present disclosure that any oil-based viscosifier, such as organophilic clays, normally amine treated clays, oil soluble polymers, polyamide resins, polycarboxylic acids, soaps, alkyl diamides, triphenylethylene may also be optionally incorporated into the fluid formulation. The amount of viscosifier used in the composition may vary upon the end use of the composition. However, normally about 0.1% to 6% by weight range is sufficient for most applications.

Other oil-swellable materials may include natural rubbers, nitrile rubbers, hydrogenated nitrile rubber, ethylene-propylene-copolymer rubber, ethylene-propylene-diene terpolymer rubber, butyl rubber, halogenated butyl rubber, brominated butyl rubber, chlorinated butyl rubber, chlorinated polyethylene, starch-polyacrylate acid graft copolymer, polyvinyl alcohol cyclic acid anhydride graft copolymer, isobutylene maleic anhydride, polyacrylates, acrylate butadiene rubber, vinylacetate-acrylate copolymer, polyethylene oxide polymers, carboxymethyl cellulose type polymers, starch-polyacrylonitrile graft copolymers, styrene, styrene-butadiene rubber, polyethylene, polypropylene, ethylene-propylene comonomer rubber, ethylene propylene diene monomer rubber, ethylene vinyl acetate rubber, hydrogenized acrylonitrile-butadiene rubber, acrylonitrile butadiene rubber, isoprene rubber, neoprene rubbers, sulfonated polyethylenes, ethylene acrylate, epichlorohydrin ethylene oxide copolymers, ethylene-proplyene rubbers, ethylene-propylene-diene terpolymer rubbers, ethylene vinyl acetate copolymer, acrylamides, acrylonitrile butadiene rubbers, polyesters, polyvinylchlorides, hydrogenated acrylonitrile butadiene rubbers, fluoro rubber, fluorosilicone rubbers, silicone rubbers, poly 2,2,1-bicyclo heptenes (polynorbornene), alkylstyrenes, or chloroprene rubber. While the specific chemistry is of no limitation to the present methods, oil-swelling polymer compositions may also include oil-swellable elastomers.

Weighting agents or density materials suitable for use the fluids disclosed herein include galena, hematite, magnetite, iron oxides, ilmenite, barite, siderite, celestite, dolomite, calcite, and the like. The quantity of such material added, if any, may depend upon the desired density of the final composition. Typically, weighting agent is added to result in a fluid density of up to about 24 pounds per gallon. The weighting agent may be added up to 21 pounds per gallon in one embodiment, and up to 19.5 pounds per gallon in another embodiment. Further, in another embodiment, the weighting agent may be used to result in a fluid density of greater than 8 pounds per gallon and up to 16 pounds per gallon. Other embodiments may have a lower limit of any of 7, 8, 9, 10, 11, 12, or 13 pounds per gallon, and an upper limit of any of 9, 10, 11, 12, 13, 14, 15, or 16 pounds per gallon, where any lower limit can be used in combination with any upper limit.

In particular embodiments, the solid weighting agent may have a sufficiently smaller particular particle size range and/or distribution than API grade weighting agents. The present disclosure has found that the wellbore fluids of the present disclosure may possess such solid component in a smaller particle size range so that density of the fluid may be achieved without significant settling of the weighting agents. As used herein, “micronized” refers to particles having a smaller particle size range than API grade weighing agents. Suitable ranges that fall within this classification include particles that are within micron or sub-micron ranges, discussed in more detail below.

One having ordinary skill in the art would recognize that selection of a particular material may depend largely on the density of the material as generally, the lowest wellbore fluid viscosity at any particular density is obtained by using the highest density particles. In some embodiments, the weighting agent may be formed of particles that are composed of a material of specific gravity of at least 2.3; at least 2.4 in other embodiments; at least 2.5 in other embodiments; at least 2.6 in other embodiments; and at least 2.68 in yet other embodiments. Higher density weighting agents may also be used with a specific gravity of about 4.2, 4.4 or even as high as 5.2. For example, a weighting agent formed of particles having a specific gravity of at least 2.68 may allow wellbore fluids to be formulated to meet most density requirements yet have a particulate volume fraction low enough for the fluid to be pumpable. However, other considerations may influence the choice of product such as cost, local availability, the power required for grinding, and whether the residual solids or filtercake may be readily removed from the well. In particular embodiments, the wellbore fluid may be formulated with calcium carbonate or another acid-soluble material.

The solid weighting agents may be of any particle size (and particle size distribution), but some embodiments may include weighting agents having a smaller particle size range than API grade weighing agents, which may generally be referred to as micronized weighting agents. Such weighting agents may generally be in the micron (or smaller) range, including submicron particles in the nanosized range.

In some embodiments, the average particle size (d50, the size at which 50% of the particles are smaller) of the weighting agents may range from a lower limit of greater than 5 nm, 10 nm, 30 nm, 50 nm, 100 nm, 200 nm, 500 nm, 700 nm, 0.5 micron, 1 micron, 1.2 microns, 1.5 microns, 3 microns, 5 microns, or 7.5 microns to an upper limit of less than 500 nm, 700 microns, 1 micron, 3 microns, 5 microns, 10 microns, 15 microns, 20 microns, where the particles may range from any lower limit to any upper limit. In other embodiments, the d90 (the size at which 90% of the particles are smaller) of the weighting agents may range from a lower limit of greater than 20 nm, 50 nm, 100 nm, 200 nm, 500 nm, 700 nm, 1 micron, 1.2 microns, 1.5 microns, 2 microns, 3 microns, 5 microns, 10 microns, or microns to an upper limit of less than 30 microns, 25 microns, 20 microns, 15 microns, 10 microns, 8 microns, 5 microns, 2.5 microns, 1.5 microns, 1 micron, 700 nm, 500 nm, where the particles may range from any lower limit to any upper limit. The above described particle ranges may be achieved by grinding down the materials to the desired particle size or by precipitation of the material from a bottoms up assembly approach. Precipitation of such materials is described in U.S. Pat. No. 2010/009874, which is assigned to the present assignee and herein incorporated by reference. One of ordinary skill in the art would recognize that, depending on the sizing technique, the weighting agent may have a particle size distribution other than a monomodal distribution. That is, the weighting agent may have a particle size distribution that, in various embodiments, may be monomodal, which may or may not be Gaussian, bimodal, or polymodal.

Lightweight agents, having typically a density of less than 2 g/cm³, and preferably less than 0.8 g/cm³, may also be used when density has to be decreased. These can be selected, for example, from hollow microspheres, in particular silico-aluminate microspheres or cenospheres, synthetic materials such as hollow glass beads, and more particularly beads of sodium-calcium-borosilicate glass, ceramic microspheres, e.g. of the silica-alumina type, or beads of plastics material such as polypropylene beads.

The wellbore strengthening composition may also contain other common treatment fluid ingredients such as fluid loss control additives, dyes, tracers, anti-foaming agents when necessary, and the like, employed in typical quantities, known to those skilled in the art. Of course, the addition of such other additives should be avoided if it will detrimentally affect the basic desired properties of the treatment fluid.

Composite Preparation

In embodiments, the composite is formed by mixing all of the desired components together, including the diene pre-polymer, the diluent, solvent, initiators and additives, at the wellsite, prior to pumping the mixture downhole.

In further embodiments, a diene pre-polymer, reactive diluents, base oil solvent, and rheological additive may be pre-mixed off-site and included in barrels or the like. At the well-site, prior to pumping downhole, the initiator may be added to the pre-mixed formulation. Depending on the particular additives desired, one or more of such additives, such as a weighting agent, may be added either at the wellsite or in the pre-packaged barrel. Further, in yet another alternative method, instead of being pre-mixed with the other components, the rheological additive may be mixed into the formulation at the well-site.

Setting Temperature

In some embodiments, the diene pre-polymer, the reactive diluent and the initiator may be reacted at a temperature ranging from about 30 to about 250° C.; from about 50 to about 150° C. in other embodiments; and from about 60 to about 100° C. in yet other embodiments, and such temperatures may include those experienced downhole such that the initiation of polymerization between the diene pre-polymer and reactive diluents occurs upon exposure to the wellbore temperatures upon being placed downhole. However, one of ordinary skill in the art would appreciate that, in various embodiments, the reaction temperature may determine the amount of time required for composite formation.

Time Required for Composite Formation

Embodiments of the composites disclosed herein may be formed by mixing a diene pre-polymer and reactive diluent with an initiator. In some embodiments, a composite may form within about 3 hours of mixing the formulation components with the initiator. In other embodiments, a composite may form within 6 hours of mixing the components with the initiator; or within 9 hours of mixing in other embodiments.

The initiator upon aging at temperatures of about 30° C. to about 250° C. prompts the formation of free radicals in the polymers and/or diluent monomers. The radicals in turn cause the bond formation of the polymers and/or diluent monomers. The bonding changes the liquid composition into a hard composite.

Embodiments of the composite materials disclosed herein may possess greater flexibility in their use in wellbore and oilfield applications, as compared to conventional cement. For example, the composite material may be used in applications including: primary cementing operations, zonal isolation; loss circulation; wellbore (WB) strengthening treatments; reservoir applications such as in controlling the permeability of the formation, etc. Depending on the particular application, a resin formulation of the present disclosure may be directly emplaced into the wellbore by conventional means known in the art into the region of the wellbore in which the resin formulation is desired to cure or set into the composite. Alternatively, the resin formulation may be emplaced into a wellbore and then displaced into the region of the wellbore in which the resin formulation is desired to set or cure.

According to various embodiments, the formulations of the present disclosure may be used where a casing string or another liner is to be sealed and/or bonded in the annular space between the walls of the borehole and the outer diameter of the casing or liner with composite material of the present disclosure. For example, following drilling of a given interval, once placement of a casing or liner is desired, the drilling fluid may be displaced by a displacement fluid. The drill bit and drill string may be pulled from the well and a casing or liner string may be suspended therein. The present formulation of components may be pumped through the interior of the casing or liner, and following the present fluid formulation, a second displacement fluid (for example, the fluid with which the next interval will be drilled or a fluid similar to the first displacement fluid) may displace the present fluid into the annulus between the casing or liner and borehole wall. Once the composite material has cured and set in the annular space, drilling of the next interval may continue. Prior to production, the interior of the casing or liner may be cleaned and perforated, as known in the art of completing a wellbore. Alternatively, the formulations may be pumped into a selected region of the wellbore needing consolidation, strengthening, etc., and following curing, a central bore may be drilled out.

Further, in embodiments, a casing may be run into the hole having a fluid therein, followed by pumping a sequence of a spacer fluid ahead of a resin formulation according to the present disclosure, after which a displacement fluid may displace the formulation into the annulus. Further embodiments may use both a cementious slurry and a resin formulation (pumped in either order, cement then resin or resin then cement) and/or multiple volumes of cement and resin, such as cement-resin-cement or resin-cement-resin, with appropriate placement of spacers and/or wiper plugs. When using both cement and a resin formulation, different setting times between the cement and resin formulation may be used so that the resin may be set in compression or the resin may be set while the cement is still fluid.

Wellbore stability may also be enhanced by the injection of the resin formulation into formations along the wellbore. The mixture may then react or continue to react, strengthening the formation along the wellbore upon polymerization of the diene prepolymer and reactive diluent.

Embodiments of the gels disclosed herein may be used to enhance secondary oil recovery efforts. In secondary oil recovery, it is common to use an injection well to inject a treatment fluid, such as water or brine, downhole into an oil-producing formation to force oil toward a production well. Thief zones and other permeable strata may allow a high percentage of the injected fluid to pass through only a small percentage of the volume of the reservoir, for example, and may thus require an excessive amount of treatment fluid to displace a high percentage of crude oil from a reservoir.

To combat the thief zones or high permeability zones of a formation, embodiments of the resin formulations disclosed herein may be injected into the formation. The resin formulation injected into the formation may react and partially or wholly restrict flow through the highly conductive zones. In this manner, the composite may effectively reduce channeling routes through the formation, forcing the treating fluid through less porous zones, and potentially decreasing the quantity of treating fluid required and increasing the oil recovery from the reservoir.

In other embodiments, the composites of the present disclosure may be formed within the formation to combat the thief zones. The resin formulation may be injected into the formation, allowing the components to penetrate further into the formation than if a gel was injected. By forming the composites in situ in the formation, it may be possible to avert channeling that may have otherwise occurred further into the formation, such as where the treatment fluid traverses back to the thief zone soon after bypassing the injected gels as described above.

As another example, embodiments of the resin formulation disclosed herein may be used as a loss circulation material (LCM) treatment when excessive seepage or circulation loss problems are encountered. In such an instance, the resin formulation may be emplaced into the wellbore into the region where excessive fluid loss is occurring and allowed to set. Upon setting, the composite material may optionally be drilled through to continue drilling of the wellbore to total depth.

In some embodiments, the diene prepolymer, reactive diluents, and initiator may be mixed prior to injection of the formulation into the drilled formation. The mixture may be injected while maintaining a low viscosity, prior to polymerization formation, such that the composite may be formed downhole. In other embodiments, one or more of the components, such as the initiator, may be injected into the formation in separate shots, mixing and reacting to form a composite in situ. In this manner, premature reaction may be avoided. For example, a first mixture containing diene prepolymer and/or reactive diluent may be injected into the wellbore and into the lost circulation zone. A second mixture containing an initiator (and optionally, one of the diene prepolymer and/or reactive diluents) may be injected, causing the diene prepolymer and reactive diluent to crosslink in situ. The hardened composite may plug fissures and thief zones, closing off the lost circulation zone.

Methods of the present application may isolate pressures between metal tubulars using the composite materials of the present application. For example, in drilling and completion applications, mechanical isolation devices may be used to partition the well. A mechanical packer (containing a sealing element of metal and/or elastomer) may be placed in a well and once set in place, will provide pressure isolation to a tested rating, such as to separate producing and non-producing intervals in a completion.

A slurry of the present disclosure may be placed in a wellbore through pumping or settling and solidify, isolating a pressure zone. Once hardened, the material may have some flexibility but adheres to the metal tubulars within the wellbore, providing pressure isolation.

In well suspensions, this may provide a temporary barrier within casing. In completion operations, this barrier may be placed between an outer casing and an inner tubing to isolate pressure. One application may include placing the slurry on top of a conventionally set packer for additional reliability or as a repair mechanism. Completion tubing is capable of flexing with changing in temperature and the ability of this material to adhere yet be flexible without fracturing. This may provide zonal isolation typically only provided through elastomer seals which may not be pumped downhole.

In another embodiment, the composite material may be used as a well remediation application where the slurry is placed in between two concentric casing strings to act as a pressure barrier. For example, this may take place when a casing cement does not sufficiently isolate pressurized zones, allowing fluid to pass between the casing strings. The slurry material of the present application may be pumped or placed in the space behind the cement to seal behind the leaking space.

Referring to FIG. 7, use of the composite materials of the present disclosure as an isolation barrier for well suspension is shown. As shown in FIG. 7, a suspension material 106 (i.e., the slurry of the present disclosure) is pumped into wellbore in which a drill pipe 104 is located. Upon consolidation, the suspension material 106 may adhere to casing 102 and solidify to create a barrier.

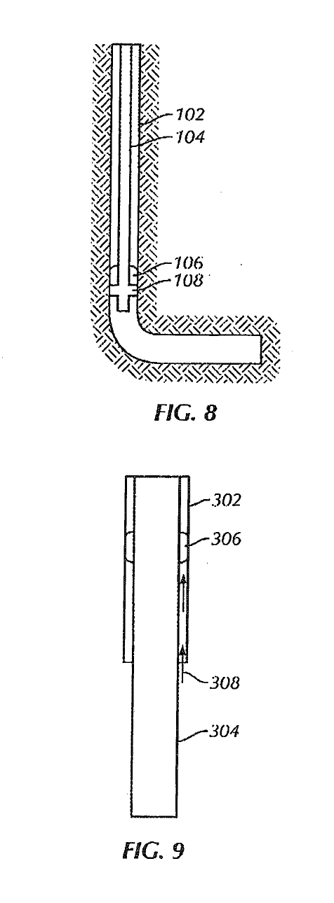

Referring now to FIG. 8, use of the composite materials of the present disclosure as a repair/secondary seal for a leaking mechanical packer is shown. As shown in FIG. 8, a packer 208 isolates two regions of wellbore 202, the producing region and non-producing region. Production tubing 204 ends in the lower, producing region of the well to produce therefrom. If the packer 208 begins to leak fluid therethrough, a slurry of the present disclosure may be placed above the packer 208 and allowed to solidify between casing/wellbore 202 and the production tubing 204 to isolate the lower region from the upper region and provide a backup/secondary seal to the leaking packer.

Referring now to FIG. 9, use of the composite materials of the present disclosure as an annular mechanical barrier is shown. Specifically, as shown in FIG. 9, if there is improper isolation between a first outer casing 302 and a second inner casing 304, fluid may flow (shown at 308) between first and second casings 302, 304. Thus, placement of a composite material of the present disclosure between first and second casings 302, 304, may allow for the isolation of pressure and formation of a mechanical barrier.

### EXAMPLES

### Example 1

Three sample formulations were mixed, all of which include a polybutadiene homopolymer resin (RICON® 152 available from Cray Valley (Houston, Tex.)), isobornyl methacrylate as a reactive diluent (SR 423, available from Sartomer Technology Co. (Exton, Pa.)), a base oil (AMODRILL 1000, available from Amoco Chemical Company (Chicago, Ill.)), and hydrophobic fumed nanosilica (AEROSIL® R974 available from Evonik Degussa Corporation (Parsippany, N.J.)). The samples were formulated as shown in Table 1 below.

TABLE 1

| | Sample Nos. | | |
|---|---|---|---|
| | 1 | 2 | 3 |
| PB Resin (% w/w) | 25 | 17.85 | 10.7 |
| Reactive Diluent (% w/w) | 50 | 56.25 | 62.5 |
| Base Oil (% w/w) | 25 | 25.9 | 26.8 |
| Fumed Silica (ppb) | 3 | 5 | 7 |

Each of the fluids was weighted to 12 ppg with M-I BAR, an API grade barite available from M-I SWACO, and the rheology of the formulations was tested using a Farm 35 Viscometer (Fann Instrument Company), at 67° F., 100° F., and 150° F., as shown below in Table 2, as compared to an synthetic oil-based drilling fluid system (Comparative Sample or CS) sold under the name RHELIANT at 12 ppg.

TABLE 2

| | 12 ppg at 67 F. | | | | 12 ppg at 100 F. | | | | 12 ppg at 150 F. | | | |
|---|---|---|---|---|---|---|---|---|---|---|---|---|
| | CS | 1 | 2 | 3 | CS | 1 | 2 | 3 | CS | 1 | 2 | 3 |
| □₆₀₀ | 120 | 184 | 136 | 104 | 75 | 94 | 75 | 70 | 60 | 46 | 43 | 41 |
| □₃₀₀ | 80 | 94 | 70 | 54 | 43 | 48 | 38 | 35 | 37 | 24 | 22 | 20 |
| □₂₀₀ | 42 | 64 | 48 | 38 | 32 | 32 | 26 | 24 | 28 | 16 | 14 | 13 |
| □₁₀₀ | 22 | 33 | 26 | 21 | 20 | 17 | 14 | 13 | 19 | 8 | 8 | 8 |
| □₆ | 12 | 3 | 3 | 3 | 7 | 2 | 2 | 2 | 9 | 1 | 2 | 2 |
| □₃ | 10 | 2 | 2 | 2 | 6 | 1 | 1 | 1 | 9 | 1 | 1 | 1 |

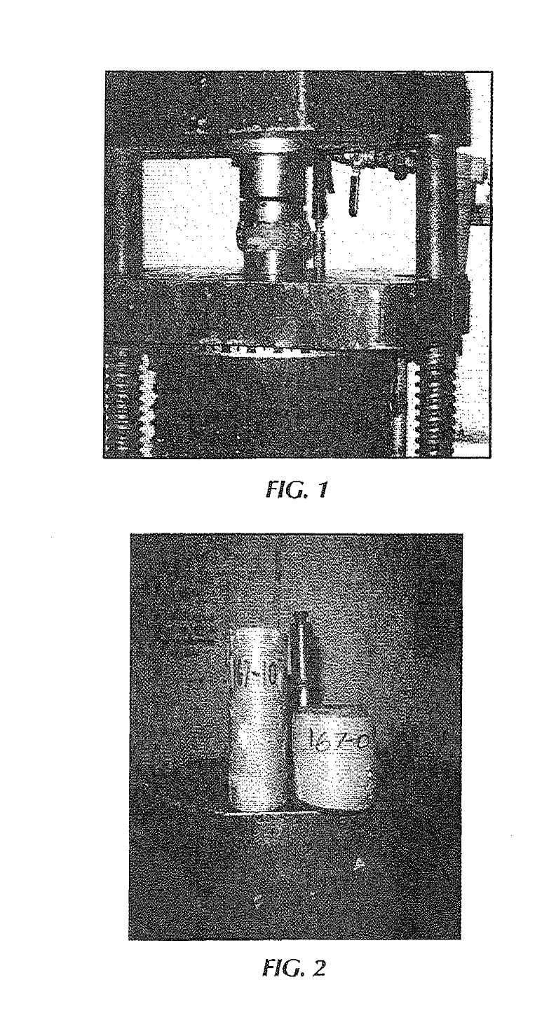

Samples 1-3 were allowed to cure by addition of dibenzoyl peroxide. Upon curing, the unconfined compressive strength of each composite material was tested by application of pressure from uniaxial directions to the sample of cured material, as illustrated in FIG. 1. FIG. 2 shows the comparative visual images of Sample 1 before and immediately after compression. After 3 hours, the compressed sample shown in FIG. 2 expanded to its initial height.

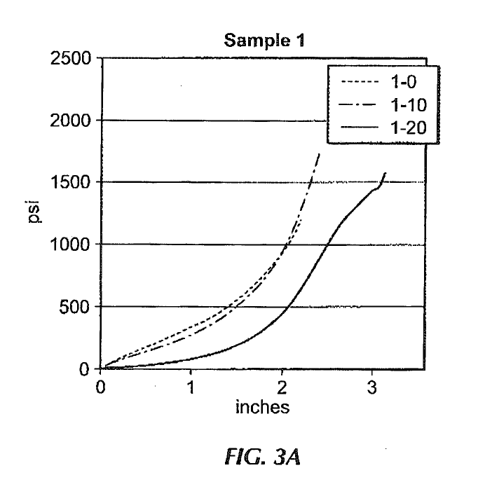

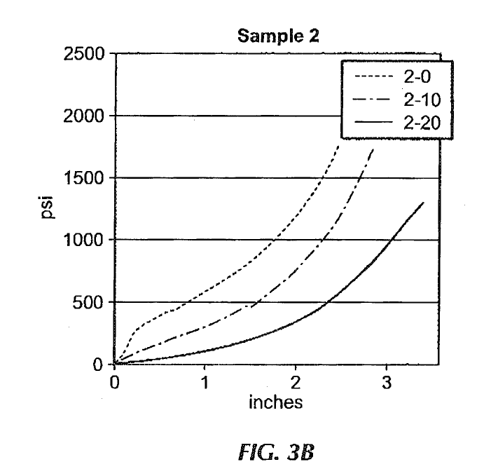

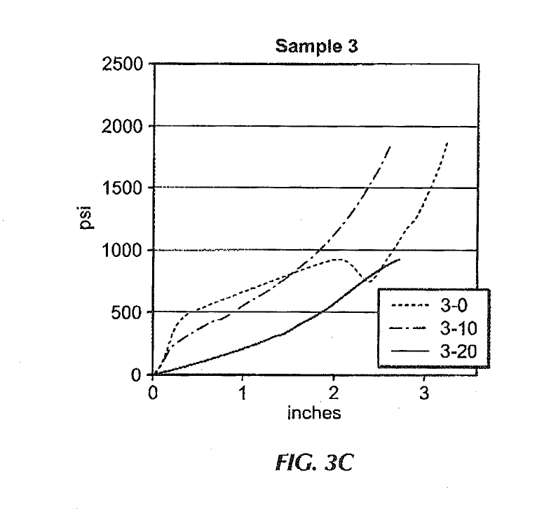

The effect of contamination in the samples was measured by plotting the applied pressure versus the height reduction in each sample after contaminating each respective formula with 0% by volume, 10% by volume, and 20% by volume with a synthetic oil-based drilling fluid system under the name RHELIANT (which had a corresponding mud weight of 12 ppg). These plots are shown in FIGS. 3A-3C for Samples 1-3, respectively.

### Example 2

A sample formulation was mixed, which includes a polybutadiene homopolymer resin (RICON® 152 available from Cray Valley (Houston, Tex.)) (“PB Resin A”), a 80/20 blend of polybutadiene dimethacrylate and 1,6 hexanediol diacrylate esters (CN301 available from Sartomer (Exton, Pa.)) (“PB Resin B”), trimethylolpropane trimethacrylate as a reactive diluent (SR 350, available from Sartomer Technology Co. (Exton, Pa.)), a base oil (Synthetic B), an alkyl diamide filler/rheology modifier (VERSAPAC® available from M-I SWACO (Houston, Tex.)), an ultrafine barite (1012 UF available from M-I SWACO), a terpene-based inhibitor (XR 3521 available from AOC LLC (Collierville, Tenn.)), and a dibenzoyl peroxide initiator (40% suspension in diisobutyl phthalate) (Perkadox 40E available from Akzo Nobel Polymer Chemicals LLC (Chicago, Ill.)). The sample was formulated as shown in Table 3 below.

TABLE 3

| | | Pounds per barrel |
|---|---|---|
| Component | % w/w | (ppb) |
| PB Resin A | 4.94% | 24.86 |
| PB Resin B | 2.47% | 12.43 |
| Reactive Diluent | 35.44% | 178.36 |
| Inhibitor | 0.04% | 0.20 |
| Base Oil | 10.21% | 51.38 |
| Barite | 38.44% | 193.46 |
| Filler | 7.94% | 39.96 |
| Initiator | 0.53% | 2.67 |

The rheology of the sample was tested using a Fann 35 Viscometer (Fann Instrument Company), at 75° F., 100° F., and 150° F., as shown below in Table 4. Another volume of the sample was compared at room temperature, 100° F., and 150° F., against samples having 10% and 20% contamination with another fluid (EMS 4200 available from MI-SWACO (Houston, Tex.)

TABLE 4

| | | | | | | | Sample 4 + 10% | | | Sample 4 + 20% | | |
|---|---|---|---|---|---|---|---|---|---|---|---|---|
| | Sample 4A | | | Sample 4B | | | Contamination | | | Contamination | | |
| | 75 F. | 100 F. | 150 F. | RT | 100 F. | 150 F. | RT | 100 F. | 150 F. | RT | 100 F. | 150 F. |
| □₆₀₀ | 300 | 155 | 195 | 300 | 151 | — | 300 | 156 | 157 | 300 | 133 | 132 |
| □₃₀₀ | 222 | 81 | 113 | 176 | 80 | — | 173 | 83 | 97 | 169 | 71 | 91 |
| □₂₀₀ | 161 | 56 | 82 | 122 | 55 | — | 125 | 58 | 73 | 120 | 50 | 68 |
| □₁₀₀ | 97 | 31 | 54 | 65 | 29 | — | 75 | 33 | 47 | 70 | 28 | 44 |
| □₆ | 23 | 5 | 16 | 9 | 4 | — | 20 | 5 | 15 | 18 | 4 | 14 |
| □₃ | 17 | 4 | 21 | 7 | 3 | — | 16 | 7 | 17 | 14 | 3 | 14 |
| PV | 78 | 74 | 82 | 124 | 71 | — | 127 | 73 | 60 | 131 | 62 | 41 |
| YP | 144 | 7 | 31 | 52 | 9 | — | 46 | 10 | 37 | 38 | 9 | 50 |
| 10″ | 21 | 5 | 33 | 10 | 4 | — | 20 | 5 | 33 | 18 | 4 | 16 |
| Gels | | | | | | | | | | | | |
| 10′ | 18 | 10 | — | — | — | — | — | — | — | — | — | — |
| Gels | | | | | | | | | | | | |

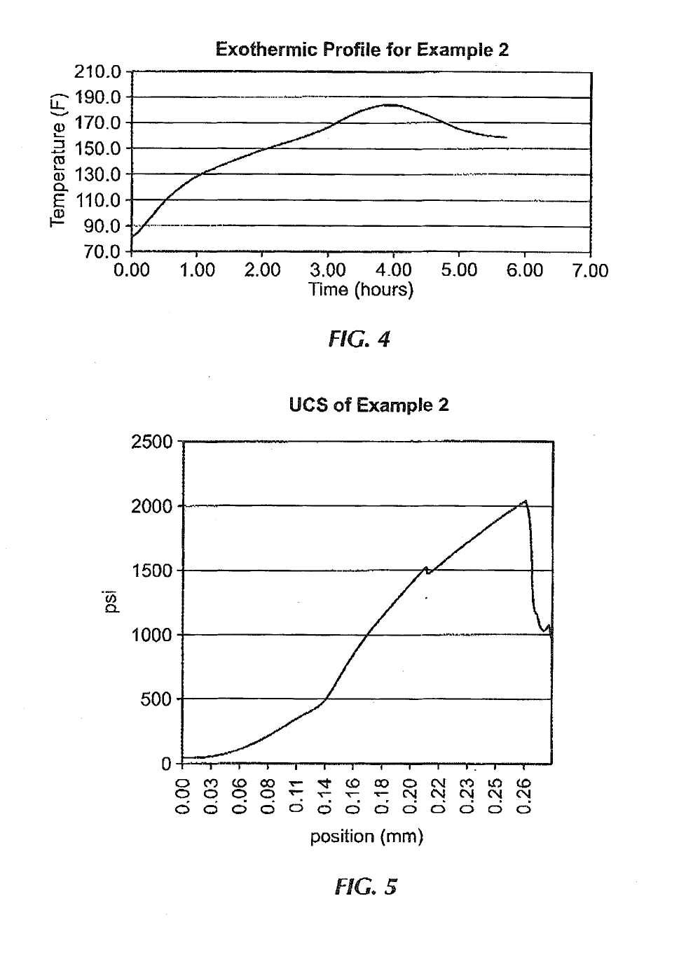

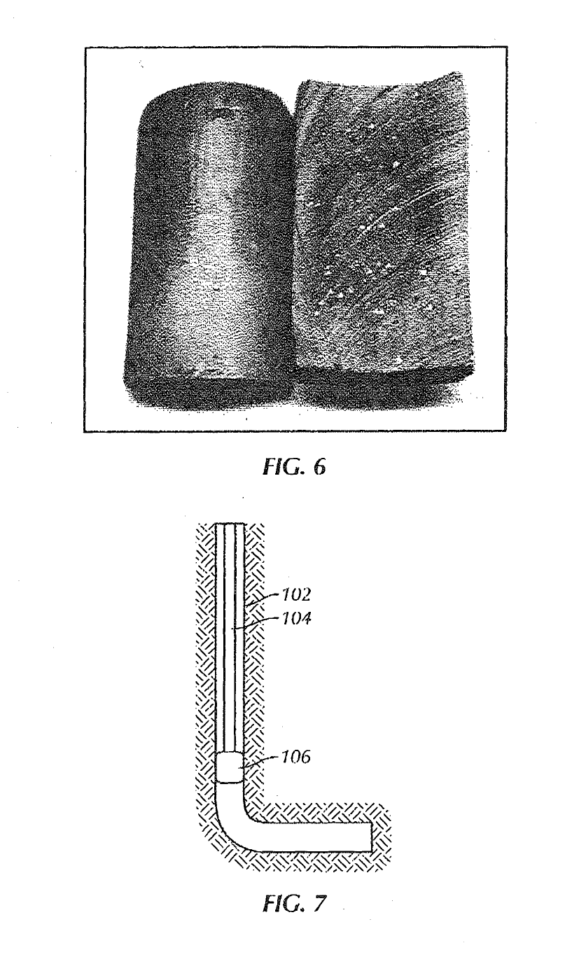

As shown in Table 4, as well as FIGS. 4-6 and visual inspection, the rheology is on the high end due to the presence of the alkyl diamide. Additionally, there is only a small exothermic peak for the curing of the sample. Specifically, the product gels at ˜2.5 hours and cures in about 5 hours. Additionally, during curing, the product maintains its volume due to the formulation and inclusion of a swellable material. Further, in a modified pipe test, the sample can hold greater than 50 psi, thus creating a good seal. The unconfined compressive strength of the product is ˜2000 psi.

Embodiments of the present disclosure may provide at least one of the following advantages. While pumping of conventional cement can cause fluid losses during pumping of the cement slurry due to the ECD of the fluid being pumped at a rate sufficient to prevent premature hardening, the present application may provide for an alternative composite material for which the density of the composite material may be selected based on the particular wellbore being treated to reduce the ECD. Further, while cement is generally susceptible to crack formation, the presence of the diene polymer in the composite material may allow the cured composite material to possess a greater ability to absorb energy and deformation without fracturing (toughness), while also possessing sufficient rigidity, due to the use of the reactive diluent in the formulation. Conventionally, composite materials that do exhibit some amount of toughness do so at the expense of fluid rheology and viscosity prior to curing, control of cure, temperature limitations, adhesion to substrate after curing, and tolerance to contamination.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method of treating a wellbore, comprising:
emplacing in at least a selected region of the wellbore, a formulation comprising:
at least one diene pre-polymer;
at least one reactive diluent;
at least one inert diluent comprising an oleaginous liquid or a mutual solvent; and
at least one initiator; and
initiating polymerization of the at least one diene pre-polymer and the at least one reactive diluent to form a composite material in the selected region of the wellbore.

2. (canceled)

3. The method of claim 1, wherein the at least one diene pre-polymer comprises a polybutadiene dimethacrylate.

4. The method of claim 1, wherein the at least one diene pre-polymer comprises a number average molecular weight ranging from about 1000 to 5000 Da.

5. The method of claim 4, wherein the at least one diene pre-polymer comprises a number average molecular weight ranging from about 2000 to 3000 Da.

6. The method of claim 1, wherein the at least one diene pre-polymer has a vinyl content ranging from about 50 to 85%.

7. The method of claim 1, wherein the at least one diene pre-polymer is present in the formulation in an amount ranging from about 10 to 30 percent by weight.

8. The method of claim 1, wherein the reactive diluent comprises at least a cycloalkyl ester of (meth)acrylate.

9. The method of claim 1, wherein the reactive diluent comprises at least one of 4-acryloylmorpholine, 2-phenoxyethyl(meth)acrylate, isodecyl(meth)acrylate, lauryl(meth)acrylate, isobornyl(meth)acrylate, trimethylolpropane tri(meth)acrylate, tripropylene glycol di(meth)acrylate, or bisphenol A ethoxylate diacrylate.

10. The method of claim 1, wherein the reactive diluent is in liquid form and has a viscosity at 25° C. ranging from about 2 to 20 cps.

11. The method of claim 1, wherein the reactive diluents is selected such that if in homopolymerized form, the homopolymerized reactive diluent has a glass transition temperature ranging from about 90 to 130° C.

12. The method of claim 1, wherein the reactive diluent is at least oil-miscible.

13. The method of claim 1, wherein the reactive diluent is present in an amount ranging from about 30 to 80 percent by weight of the formulation.

14. The method of claim 1, wherein the inert diluent comprises at least one of diesel oil; mineral oil; or a synthetic oil.

15. The method of claim 1, wherein the inert diluent is present in an amount ranging from about 10 to 30 percent by weight of the formulation.

16. The method of claim 1, wherein the initiator comprises at least one free-radical initiator.

17. The method of claim 1, wherein the formulation further comprises at least one rheological modifier.

18. The method of claim 1, wherein the formulation further comprises at least one weighting agent.

19. The method of claim 1, wherein the emplacing comprises emplacing the formulation in an annular region formed between a wellbore wall and a casing or liner.

20. The method of claim 1, wherein the emplacing comprises emplacing the formulation in an annular region formed between a first casing string and a second casing string.

21. The method of claim 1, wherein the emplacing comprises emplacing the formulation between a production tubing and a wellbore wall or casing string and adjacent a mechanical packer.

22. A composite material, comprising:
a crosslinked polymer network of a diene polymer and cycloalkyl ester of (meth)acrylate; and
a plurality of weighting agent particles and/or rheological additive dispersed in the crosslinked polymer network.

23. The composite material of claim 22, wherein the at least one diene polymer comprises a polybutadiene homopolymer.

24. The composite material of claim 22, wherein the weighting agent particles comprise barite.

25. The composite material of claim 22, wherein the rheological additive comprises at least one of carbon nanotubes, fumed silica, fibrous structures or styrenic block copolymers.

26. A composite material, comprising:
a crosslinked polymer network of a diene homopolymer, a (meth)acrylated diene polymer, and one of 4-acryloylmorpholine, 2-phenoxyethyl(meth)acrylate, isodecyl(meth)acrylate, lauryl(meth)acrylate, isobornyl(meth)acrylate, trimethylolpropane tri(meth)acrylate, tripropylene glycol di(meth)acrylate, or bisphenol A ethoxylate diacrylate; and
a plurality of weighting agent particles and/or rheological additive dispersed in the crosslinked polymer network.
